(19) United States
(12) Patent Application Publication
(10) Pub. No.: US 2026/0250468 A1
(43) Pub. Date: Aug. 27, 2026

(54) HUMIC ACID RICH IN AROMATIC OXYGEN AND PREPARATION METHOD THEREOF

(71) Applicant: Institute of Agricultural Resources and Regional Planning, Chinese Academy of Agricultural Sciences, Beijing (CN)

(72) Inventors: Liang Yuan, Beijing (CN); Yanting Li, Beijing (CN); Bingqiang Zhao, Beijing (CN); Shuiqin Zhang, Beijing (CN); Meng Xu, Beijing (CN); Jiukai Xu, Beijing (CN); Yingqiang Zhang, Beijing (CN); Wei Wang, Beijing (CN)

(21) Appl. No.: 19/326,073

(22) Filed: Sep. 11, 2025

(30) Foreign Application Priority Data
Feb. 25, 2025 (CN) 202510207733.0

(51) Int. Cl. C08H 7/00; B01J 21/08; B01J 23/889; B01J 37/00; B01J 37/02; B01J 37/08

(52) U.S. Cl. CPC C08H 6/00; B01J 21/08; B01J 23/8892; B01J 37/009; B01J 37/0236; B01J 37/08

(57) ABSTRACT

The invention belongs to the technical field of general methods in organic chemistry, specifically relating to a humic acid rich in aromatic oxygen and a preparation method thereof. By combining the silica-supported cobalt oxide-manganese oxide-magnesium oxide catalyst with the hydrogen peroxide solution, the invention selectively breaks and destroys the carboxyl structures generated during the oxidation of humic acid while maximizing the retention of the aromatic ring structure of humic acid. Oxygen atoms exposed after carboxyl cleavage connect to undestroyed benzene rings, thereby targeting an increase in the aromatic oxygen content of humic acid. The humic acid treated with the oxidant of the invention, when mixed with urea, effectively reduces ammonia volatilization loss from urea and enhances adsorption of soil ammonium nitrogen, thereby retaining more nitrogen in the soil, improving soil nitrogen supply intensity, and reducing urea loss.

### TECHNICAL FIELD

The invention belongs to the technical field of general methods in organic chemistry, specifically relating to a humic acid rich in aromatic oxygen and a preparation method thereof.

### BACKGROUND ART

Urea is a primary nitrogen fertilizer in China, accounting for about 65% of total nitrogen fertilizer consumption. After application to soil, urea is rapidly hydrolyzed by urease. Aside from crop uptake and soil retention, partial nitrogen is lost through ammonia volatilization, nitrification, denitrification, runoff, and leaching, reducing fertilizer efficiency.

Humic acid is a natural organic macromolecule containing aromatic rings, carboxyl groups, phenolic hydroxyl groups, methoxy groups, and other functional groups. It has a macromolecular network structure, high cation exchange capacity, and strong physical adsorption capacity. Studies have been showed that humic acid rich in aromatic oxygen further adsorbed soil nutrients and water, stabilizes soil urease activity, promoted crop root growth and nutrient absorption, and improved nutrient utilization efficiency, playing a vital role in sustainable agriculture. The presence of aromatic oxygen functional groups also inhibited microbial activity, slowed the decomposition of humic acid by microorganisms, reduced the degradation rate of humic acid in soil, and maximizes its efficacy.

To increase the aromatic oxygen content of humic acid, oxidation methods are commonly used. Traditional oxidation methods (e.g., HNO₃, H₂SO₄, H₂O₂) mainly increase the oxygen and carboxyl content of humic acid but suffer from disordered modification. During oxidation, oxidants damage the aromatic ring structure of humic acid, leading to a significant decrease in aromaticity and a limited increase in aromatic oxygen content. It is difficult to directionally and substantially increase the aromatic oxygen content of humic acid. Destroying the carboxyl structures generated during the oxidation of humic acid while maximizing the retention of its aromatic ring structure is a challenge for directionally enhancing the aromatic oxygen of humic acid. Adding a catalyst with selective catalytic capability during oxidation is expected to connect oxygen atoms exposed after carboxyl cleavage to undestroyed benzene rings, thereby targeting an increase in the aromatic oxygen content of humic acid.

### SUMMARY OF THE INVENTION

To address the above prior art, the invention provides a humic acid rich in aromatic oxygen and a preparation method thereof, solving the technical problem of difficulty in directionally modifying the carboxyl structure of humic acid to increase its aromatic oxygen content.

To achieve the above objective, the technical solution adopted by the invention is to provide a preparation method of a humic acid rich in aromatic oxygen, comprising the following steps:
(1) dissolving humic acid in a 2 wt % sodium hydroxide solution to prepare a humic acid sodium solution with a concentration of 0.1-0.2 g/mL;
(2) adding a humic acid modification oxidant to the humic acid sodium solution under stirring, reacting at 45-55° C. for 90-150 minutes; then cooling to room temperature in an ice-water bath; the humic acid modification oxidant comprises a solid catalyst and a hydrogen peroxide solution, with a solid catalyst-to-hydrogen peroxide solution ratio of 1 g: 75-85 mL; the dosage of the humic acid modification oxidant, calculated as solid catalyst, is 1:100 by mass relative to humic acid; the solid catalyst is a silica-supported cobalt oxide-manganese oxide-magnesium oxide catalyst, with a chemical composition of Co₃O₄—Mn₃O₄—MgO@SiO₂;
(3) separating the liquid and freeze-drying to obtain the product.

On the basis of the above technical solution, the invention may be further improved as follows.

Further, the mass-to-volume ratio of solid catalyst to hydrogen peroxide solution in the humic acid modification oxidant is 1 g: 75-85 mL.

Further, the solid catalyst is prepared by the following steps:
S1: dissolving cetyltrimethylammonium bromide in water to prepare a base solution with a concentration of 0.02-0.05 mol/L;
S2: adding silicate, cobalt salt, manganese salt, and magnesium salt to the base solution, stirring for 0.5-1 hour, adjusting the system pH to 8-10, aging at 80-100° C. for 1-5 hours, filtering, and collecting the solid to obtain a precursor;
S3: drying the precursor at 100-120° C. for 10-15 hours, then calcining at 280-320° C. for 3-8 hours.

Further, the molar ratio of silicate, cobalt salt, manganese salt, and magnesium salt is 10:1-3:1-2:0.5-2, and the silicate-to-base solution ratio is 1 mol: 10 mL.

Further, the silicate is sodium silicate; the cobalt salt is cobalt chloride or cobalt nitrate; the manganese salt is manganese sulfate, manganese chloride, or manganese nitrate; the magnesium salt is magnesium sulfate, magnesium chloride, or magnesium nitrate.

Further, in S2, the aging temperature is 90° C. and the aging time is 3 hours; in S3, the drying temperature is 110° C., the drying time is 12 hours, the calcination temperature is 300° C., and the calcination time is 5 hours.

Further, the mass concentration of the hydrogen peroxide solution is 0.5%.

Further, the dosage of the humic acid modification oxidant, calculated as solid catalyst, is 1:100 by mass relative to humic acid;

Further, in step (2), the reaction temperature is 50° C., and the reaction time is 120 minutes. The invention further provides a humic acid rich in aromatic oxygen, which is prepared by the above preparation method.

The beneficial effects of the invention are as follows.

1. By combining the silica-supported cobalt oxide-manganese oxide-magnesium oxide catalyst with the hydrogen peroxide solution, the invention selectively breaks and destroys the carboxyl structures generated during the oxidation of humic acid while maximizing the retention of the aromatic ring structure of humic acid. Oxygen atoms exposed after carboxyl cleavage connect to undestroyed benzene rings, thereby targeting an increase in the aromatic oxygen content of humic acid.

2. The humic acid treated with the oxidant of the invention, when mixed with urea, effectively reduces ammonia volatilization loss from urea and enhances adsorption of soil ammonium nitrogen, thereby retaining more nitrogen in the soil, improving soil nitrogen supply intensity, and reducing urea loss.

### BRIEF DESCRIPTION OF ACCOMPANY DRAWINGS

FIG. 1 is a XPS C1s peak-fitting spectra of HA, OHA, and COHA;

FIG. 2 is an average double-bond equivalent minus oxygen values of COHA, OHA, and HA;

FIG. 3 is an average aromaticity indices of COHA, OHA, and HA;

FIG. 4 shows the effects of COHA, OHA, and HA on urea ammonia volatilization rate;

FIG. 5 shows the effects of COHA, OHA, and HA on cumulative ammonia volatilization;

FIG. 6 shows the effects of COHA, OHA, and HA on soil ammonium nitrogen content during urea conversion.

### SPECIFIC EMBODIMENT OF THE INVENTION

The specific implementations of the invention will be described in detail hereinafter with reference to the embodiments.

### Embodiment 1

A humic acid modification oxidant, comprising a solid catalyst and a hydrogen peroxide solution, with a solid catalyst-to-hydrogen peroxide solution ratio of 1 g: 80 mL; wherein the mass concentration of the hydrogen peroxide solution is 0.5%; the solid catalyst is a silica-supported cobalt oxide-manganese oxide-magnesium oxide catalyst, with a chemical composition of Co₃O₄—Mn₃O₄—MgO@SiO₂, prepared by the following steps:
S1: dissolving 6 mmol cetyltrimethylammonium bromide (CTMAB) in 200 mL distilled water, ultrasonicating for 15 minutes to prepare a base solution with a concentration of 0.03 mol/L;
S2: adding 10 mmol sodium silicate, 2 mmol cobalt chloride, 1.5 mmol manganese sulfate, and 1 mmol magnesium sulfate to the base solution, stirring for 0.5 hour, adjusting the system pH to 9, aging at 90° C. for 3 hours, filtering, collecting the solid, and rinsing with hot water (90° C.) 3 times to obtain a precursor;
S3: placing the precursor in an oven at 110° C., drying for 12 hours, then calcining at 300° C. for 5 hours to obtain the solid catalyst Co₃O₄—Mn₃O₄—MgO@SiO₂.

### Embodiment 2

A humic acid modification oxidant, comprising a solid catalyst and a hydrogen peroxide solution, with a solid catalyst-to-hydrogen peroxide solution ratio of 1 g: 75 mL; wherein the mass concentration of the hydrogen peroxide solution is 0.5%; the solid catalyst is a silica-supported cobalt oxide-manganese oxide-magnesium oxide catalyst, with a chemical composition of Co₃O₄—Mn₃O₄—MgO@SiO₂, prepared by the following steps:
S1: dissolving 4 mmol cetyltrimethylammonium bromide (CTMAB) in 200 ml distilled water, ultrasonicating for 15 minutes to prepare a base solution with a concentration of 0.02 mol/L;
S2: adding 10 mmol sodium silicate, 1 mmol cobalt chloride, 2 mmol manganese sulfate, and 0.5 mmol magnesium sulfate to the base solution, stirring for 0.5 hour, adjusting the system pH to 8, aging at 80° C. for 5 hours, filtering, collecting the solid, and rinsing with hot water (80° C.) 3 times to obtain a precursor;
S3: placing the precursor in an oven at 100° C., drying for 15 hours, then calcining at 280° C. for 8 hours to obtain the solid catalyst Co₃O₄—Mn₃O₄—MgO@SiO₂.

### Embodiment 3

A humic acid modification oxidant, comprising a solid catalyst and a hydrogen peroxide solution, with a solid catalyst-to-hydrogen peroxide solution ratio of 1 g: 85 mL; wherein the mass concentration of the hydrogen peroxide solution is 0.5%; the solid catalyst is a silica-supported cobalt oxide-manganese oxide-magnesium oxide catalyst, with a chemical composition of Co₃O₄—Mn₃O₄—MgO@SiO₂, prepared by the following steps:
S1: dissolving 10 mmol cetyltrimethylammonium bromide (CTMAB) in 200 ml distilled water, ultrasonicating for 15 minutes to prepare a base solution with a concentration of 0.05 mol/L;
S2: adding 10 mmol sodium silicate, 3 mmol cobalt chloride, 1 mmol manganese sulfate, and 2 mmol magnesium sulfate to the base solution, stirring for 0.5 hour, adjusting the system pH to 10, aging at 100° C. for 1 hour, filtering, collecting the solid, and rinsing with hot water (100° C.) 3 times to obtain a precursor;
S3: placing the precursor in an oven at 120° C., drying for 10 hours, then calcining at 320° C. for 3 hours to obtain the solid catalyst Co₃O₄—Mn₃O₄—MgO@SiO₂.

### Experimental Embodiment

The humic acid modification oxidants prepared in the three embodiments of the invention have similar performance. Taking the humic acid modification oxidant prepared in Embodiment 1 as an example, the performance of the humic acid modification oxidant is explained.

The humic acid modification oxidant is used for directional catalytic oxidation modification of humic acid to prepare humic acid rich in aromatic oxygen. Specific steps are as follows.

Dissolve 10 g humic acid sample in 92 mL of 2 wt % sodium hydroxide solution. Under continuous stirring, first add the solid catalyst Co₃O₄—Mn₃O₄—MgO@SiO₂ (0.1 g) from the humic acid modification oxidant to the sodium humate solution, then add the hydrogen peroxide solution (mass concentration 0.5%, 8 mL) from the humic acid modification oxidant, and react at 50° C. for 2 hours. After the reaction, immediately cool the reaction system in ice water to prevent further reaction; when cooled to room temperature, perform solid-liquid separation, collect the reacted solution, and freeze-dry the collected solution to obtain humic acid rich in aromatic oxygen, labeled COHA.

Meanwhile, oxidize humic acid using an H₂O₂ solution as oxidant. Specific steps are as follows.

Dissolve 10 g humic acid sample in 92 mL of 2 wt % sodium hydroxide solution. Under continuous stirring, add 8 mL of 5% H₂O₂ solution to the humic acid solution, and react at 50° C. for 2 hours. After the reaction, immediately cool the reaction system in ice water to prevent further reaction; when cooled to room temperature, perform solid-liquid separation, collect the reacted solution, and freeze-dry the collected solution to obtain oxidized humic acid, labeled OHA.

Using humic acid (HA) and OHA as controls, the directional modification capability of the catalyst in the invention is evaluated.

### 1. Structural Characteristics of Directionally Modified Humic Acid

The elemental composition of different humic acids is shown in Table 1. Compared with HA, both OHA and COHA have decreased carbon, hydrogen, and nitrogen content and increased oxygen content, indicating that the oxidation process reduces carbon content and increases oxygen content in humic acid. Compared with HA, the oxygen content of OHA and COHA increased by 3.4% and 4.8%, respectively, and the oxygen content of COHA was further increased compared with OHA, indicating that introducing Co₃O₄—Mn₃O₄—MgO@SiO₂ into the oxidation system can further increase the oxygen content of humic acid. Compared with OHA, the carbon content of COHA increased, indicating that the introduction of CO₃O₄—Mn₃O₄—MgO@SiO₂ protected the aromatic ring structure of humic acid and prevented the aromatic ring structure from being over-oxidized to generate carbon dioxide escaping.

TABLE 1
Elemental Composition of Humic Acid

Elemental Composition (wt %)

| Sample | C | H | O | N |
|---|---|---|---|---|
| HA | 47.99 | 3.11 | 32.34 | 1.22 |
| OHA | 42.33 | 2.84 | 33.43 | 1.03 |
| COHA | 43.24 | 2.77 | 33.89 | 1.04 |

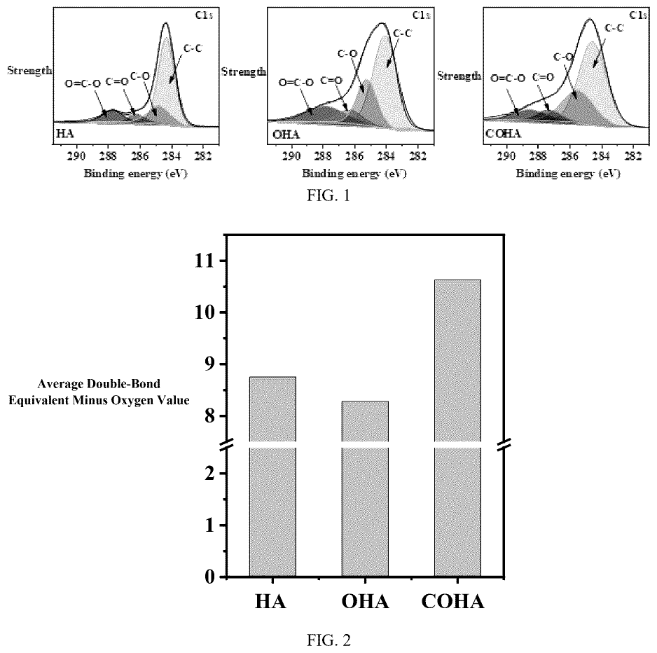

Perform C1s peak fitting on COHA, OHA, and HA. The results are shown in FIG. 1. It can be seen from FIG. 1 that compared with HA, the carboxyl content of OHA increased by 35.56%, while that of COHA decreased by 20.16%, indicating that the carboxyl groups of COHA were directionally destroyed. At the same time, compared with HA, the C—O (aromatic oxygen) content of OHA and COHA increased by 21.89% and 44.99%, respectively, further indicating that the combination of Co₃O₄—Mn₃O₄—MgO@SiO₂ and H₂O₂ can directionally break and destroy the carboxyl structure of humic acid, oxidize the carboxyl structure while protecting the aromatic carbon structure of humic acid, connect oxygen atoms to benzene rings, and thus directionally increase the aromatic oxygen content of humic acid.

The average double-bond equivalent minus oxygen value and average aromaticity index of COHA, OHA, and HA are shown in FIG. 2 and FIG. 3, respectively. The average double-bond equivalent minus oxygen value reflects the unsaturation of the carbon skeleton of humic acid. The higher the value, the lower the carboxyl content in the molecule. It can be seen from FIG. 2 that COHA has the lowest carboxyl content, while OHA oxidized with hydrogen peroxide alone has the highest carboxyl content. The average aromaticity index reflects the number of aromatic ring structures in the molecular structure of humic acid. The higher the value, the more aromatic rings in the molecule. It can be seen from FIG. 3 that the number of aromatic rings in COHA is similar to that in HA, while the aromatic ring structure in OHA is further destroyed, and the number of aromatic rings is greatly reduced. The above results indicate that the combination of Co₃O₄—Mn₃O₄—MgO@SiO₂ and H₂O₂ directionally destroys the carboxyl structure while preventing the aromatic ring structure of humic acid from being greatly destroyed, directionally increasing the aromatic oxygen content of humic acid.

### 2. Effects of Humic Acid on Urea Nitrogen Volatilization and Soil Ammonium Nitrogen Content During Urea Conversion

Add three types of humic acid (HA, OHA, and COHA) to molten urea at 130° C. at an addition rate of 0.5% (mass of humic acid divided by total mass of humic acid and urea), stir for 30 seconds, cool, pulverize, and sieve through 100 mesh to obtain three types of humic acid urea: HAU (corresponding to HA), OHAU (corresponding to OHA), and COHAU (corresponding to COHA). Urea only melted without adding humic acid (U) was used as control.

Mix 0.068 g of U, HAU, OHAU, and COHAU with 100 g soil, respectively, add to culture bottles, and use a treatment without fertilizer as control (CK). Adjust soil water content to 20%, and incubate in the dark at 25° C. in a climate chamber. During cultivation, maintain soil water content at 20% by weighing. Each treatment was repeated 3 times. On days 1, 2, 3, 5, and 7 of cultivation, absorb NH₃ using a sponge absorption method. On days 1, 2, 3, 5, 7, 14, and 28 of cultivation, determine soil ammonium nitrogen content.

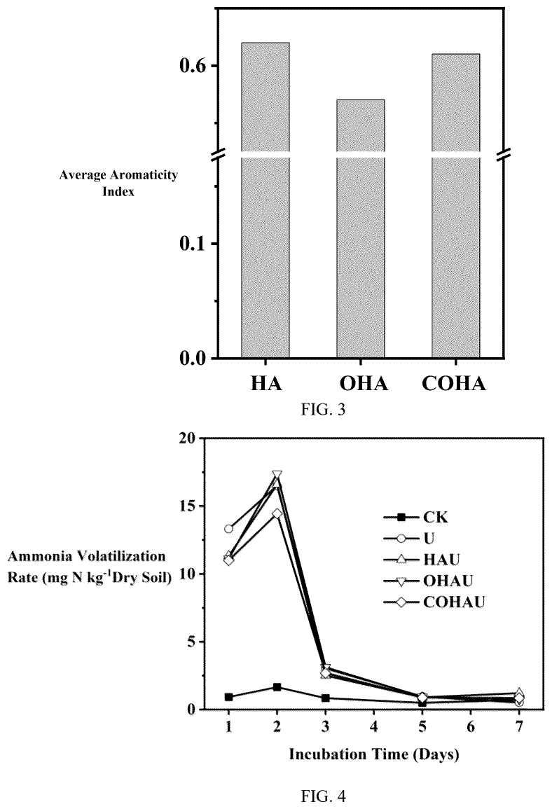

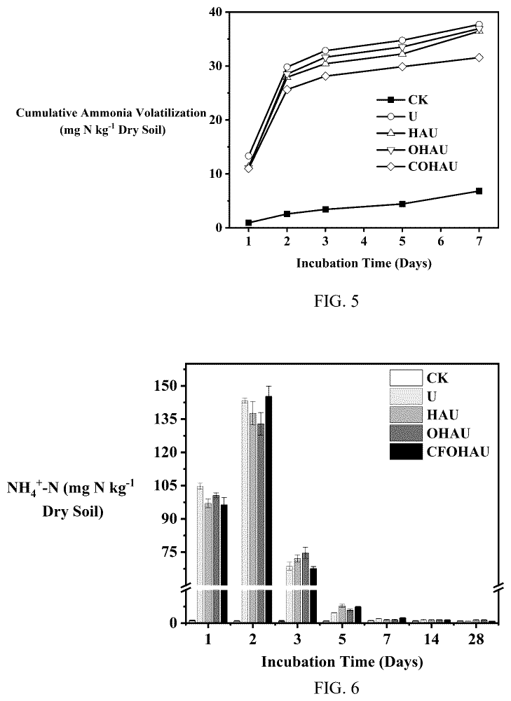

The effects of humic acid on urea ammonia volatilization rate and cumulative ammonia volatilization are shown in FIG. 4 and FIG. 5, respectively. It can be seen from FIG. 4 and FIG. 5 that compared with U, humic acid urea can reduce the average ammonia volatilization rate (2.95%-12.94%) and cumulative ammonia volatilization (2.1%-16.26%). Compared with HAU, the average ammonia volatilization rate and cumulative ammonia volatilization of OHAU increased by 2.46% and 1.33%, respectively, while those of COHAU decreased by 8.22% and 13.41%, respectively, indicating that COHA rich in aromatic oxygen can further reduce urea ammonia volatilization loss compared with HA.

The effect of humic acid on soil ammonium nitrogen content during urea conversion is shown in FIG. 6. It can be seen from the figure that compared with U, the soil ammonium nitrogen content of humic acid urea decreased on day 1 of cultivation, and the soil ammonium nitrogen content of COHAU further decreased compared with HAU. At the peak of ammonia volatilization on day 2 of cultivation, the ammonium nitrogen content of HAU was low, which is consistent with the increase in ammonia volatilization of HAU on day 2. Compared with HAU, the soil ammonium nitrogen content of COHAU increased by 5.60%, indicating that COHA rich in aromatic oxygen can further enhance the adsorption of soil ammonium nitrogen compared with HA, retain more nitrogen in the soil, improve soil nitrogen supply intensity, and reduce urea loss.

Although the specific implementations of the invention are described in detail with reference to the embodiments, it should not be construed as limiting the protection scope of this patent. Within the scope described in the claims, various modifications and variations that can be made by those skilled in the art without creative work still fall within the protection scope of this patent.

1. A preparation method of a humic acid rich in aromatic oxygen, comprising the following steps:
(1) dissolving humic acid in a 2 wt % sodium hydroxide solution to prepare a humic acid sodium solution with a concentration of 0.1-0.2 g/mL;
(2) adding a humic acid modification oxidant to the humic acid sodium solution under stirring, reacting at 45-55° C. for 90-150 minutes; then cooling to room temperature in an ice-water bath; the humic acid modification oxidant comprises a solid catalyst and a hydrogen peroxide solution, with a solid catalyst-to-hydrogen peroxide solution ratio of 1 g: 75-85 mL; the dosage of the humic acid modification oxidant, calculated as solid catalyst, is 1:100 by mass relative to humic acid; the solid catalyst is a silica-supported cobalt oxide-manganese oxide-magnesium oxide catalyst, with a chemical composition of Co₃O₄—Mn₃O₄—MgO@SiO₂;
(3) separating the liquid and freeze-drying to obtain the product.

2. The preparation method of a humic acid rich in aromatic oxygen of claim 1, wherein the solid catalyst is prepared by the following steps:
S1: dissolving cetyltrimethylammonium bromide in water to prepare a base solution with a concentration of 0.02-0.05 mol/L;
S2: adding silicate, cobalt salt, manganese salt, and magnesium salt to the base solution, stirring for 0.5-1 hour, adjusting the system pH to 8-10, aging at 80-100° C. for 1-5 hours, filtering, and collecting the solid to obtain a precursor;
S3: drying the precursor at 100-120° C. for 10-15 hours, then calcining at 280-320° C. for 3-8 hours.

3. The preparation method of a humic acid rich in aromatic oxygen of claim 2, wherein the molar ratio of silicate, cobalt salt, manganese salt, and magnesium salt is 10:1-3:1-2:0.5-2, and the silicate-to-base solution ratio is 1 mol: 10 mL.

4. The preparation method of a humic acid rich in aromatic oxygen of claim 3, wherein the silicate is sodium silicate; the cobalt salt is cobalt chloride or cobalt nitrate; the manganese salt is manganese sulfate, manganese chloride, or manganese nitrate; the magnesium salt is magnesium sulfate, magnesium chloride, or magnesium nitrate.

5. The preparation method of a humic acid rich in aromatic oxygen of claim 2, wherein in S2, the aging temperature is 90° C. and the aging time is 3 hours; in S3, the drying temperature is 110° C., the drying time is 12 hours, the calcination temperature is 300° C., and the calcination time is 5 hours.

6. The preparation method of a humic acid rich in aromatic oxygen of claim 1, wherein the mass concentration of the hydrogen peroxide solution is 0.5%.

7. The preparation method of a humic acid rich in aromatic oxygen of claim 1, wherein in step (2), the reaction temperature is 50° C., and the reaction time is 120 minutes.

8. A humic acid rich in aromatic oxygen, wherein it is prepared by the preparation method of a humic acid rich in aromatic oxygen of claim 1.
